(19) United States
(12) Patent Application Publication
(10) Pub. No.: US 2024/0001565 A1
(43) Pub. Date: Jan. 4, 2024

(54) Improved Vacuum Gripping of Rough Surfaces

(71) Applicant: National Research Council of Canada, Ottawa (CA)

(72) Inventors: Charles VIDAL, Anjou (CA); Alexis GERARD, Poissy (FR); Martin DE MONTIGNY, Levis (CA); Bruno MONSARRAT, Montreal (CA); Iraj MANTEGH, Ile-Bizard (CA); Bruno CHAPDELAINE, Montreal (CA)

(73) Assignee: National Research Council of Canada, Ottawa, ON (CA)

(21) Appl. No.: 18/039,259

(22) PCT Filed: Dec. 2, 2021
(86) PCT No.: PCT/IB2021/061254

§ 371 Date: May 29, 2023

Related U.S. Application Data
(60) Provisional application No. 63/120,522, filed on Dec. 2, 2020.

(51) Int. Cl. B25J 15/06

(52) U.S. Cl. CPC B25J 15/0616

(57) ABSTRACT

The use of an unctuous sealing material (high viscosity liquid bordering on, or having, solid behavior at low shear forces) for sealing open pore, highly crushable suction cups allows for increased surface conformation for fast secure vacuum gripping, and maintenance of the pressure differential with lower energy in view of the seal. Furthermore, fast grasping is demonstrated if the unctuous sealing material protrudes from the lip.

### FIELD OF THE INVENTION

The present invention relates in general to vacuum gripping of rough surfaces, and in particular to a kit, apparatus and method, for utilizing an unctuous material to improve adhesion of known suction cups fora longer time with less suction power, and, in some configurations, requiring less force or poorer alignment to establish adhesion.

### BACKGROUND OF THE INVENTION

Temporarily grasping rough surfaces, such as mineral consolidations (e.g. concrete, bricks, pavers and unpolished natural and artificial rock) and other rough surfaces (wood, building materials, etc.) is very helpful in a number of ways: not the least of which is to manipulate large, unwieldy, delicate or cumbersome bodies that have no handle or ready clamping ends available. In particular, bodies that are: not desired to be pierced; subject to marking, damage, or deformation on contact with clamping devices; or too large to be conveniently clamped; may be grasped with vacuum grippers. As long as the body has an adequately low gas porosity, relative to the supplied vacuum pump, a seal can be maintained. One advantage, more pronounced when the body is delicate, is that load bearing support can be distributed across a vacuum gripper with many suction cups, instead of having all load concentrated at a single, or few points on the body.

Moving heavier objects, like large mineral consolidations, may require machines, but even lighter bodies that require highly repetitive deposition and arrangement, like bricklaying, stone laying and arranging, facades or fascia mounting including structural insulation panels or other building panels, or high speed production facilities for grasping products, may all employ vacuum grippers.

Vacuum grippers may be deployed for lifting, moving, separating or joining, heavy stiff bodies that have rough, load-bearing surfaces, such as required for quarrying, cutting, polishing, treating, demolding, finishing, placing, arranging, mounting, or laying mineral consolidations. Manipulating concrete slabs, precasts, walls, fascia, structural members or parts, natural or artificial stone, pavers or the like are particularly relevant commercial activities that can be accomplished with vacuum grippers. Some very large vacuum cups (e.g. having a peripheral seal perhaps ˜5 m long) are used to move precast concrete structures according to on-line advertising of ACIMEX vacuum Lifter™.

Applicant notes that non-mineral based structures may also be rough or porous and advantageously be manipulated with the grippers, including plywood and wood or pulp covered, porous woven or non-woven fabric covered, or plastic, glass, ceramic or metal surfaces having fine ridges, surface dimpling or roughening that precludes manipulation with smooth surface vacuum grippers. One example of non-mineral based structures are structural insulation panels that can be manipulated for assembly much like fascia mounting of stone or dimpled metal plate surfaces.

Vacuum grippers can also be used to support a body in relation to the object, tension or compress the body with respect to two or more surfaces (of the same or different objects), or to serve as a fiducial reference marker; to anchor, perch, or land a vehicle; or affix a sensor or mechanism on the object. For example the anchoring may be used to retain the fixture against gravity and changeable environmental conditions (subject to wind load, precipitation, water flow, or other incidental contact).

Thus the grasping may be performed to attach, ground, or support a second body to the object bearing the surface. The body can define a marker, a sensor, a tool, a robotic device, a flying, hovering, crawling, walking or rolling vehicle (piloted, otherwise operated or manned, passenger-carrying, or unmanned), or a docking station for such a vehicle. Thus the gripper may be for attaching or perching a drone or autonomous vehicle to a rough surface. A further application is to mount a decoration, advertisement, or banner onto a building or structure for an occasion, such as a holiday; or for security to “perch and stare”. A tensioned line between two such vacuum grippers can provide a support for a banner, for a temporary display on a rough building surface that was not provisioned for the purpose, without boring any holes or marking the building.

While the term ‘vacuum gripper’ may be understood to denote only a class of end effectors of robots that typically bear an array of suction cups on a frame (be it jointed, actuable, rigid, or compliant to a provisioned degree), herein the term vacuum gripper refers to a single cup, an array of cups, or system of cups operable to grip a flat, or curved surface of an object, independently of any motive mechanism, or intended use. Vacuum grippers for gasping rough surfaces are typically based on one of two kinds of suction cups: open pore polymeric suction cups that are highly crushable, and closed pore rubber suction cups that deform less, but provide far better vacuum seals. Open pore materials have myriad paths passing through them, whereas closed pore materials have independent, closed cells filled with a gas. When closed pore materials are compacted, the enclosed gas pockets compress and deform, producing a resistance force in proportion to the degree of compression, as the gas has nowhere else to go (except if the (usually) polymeric material is gas permeable, in which case a slow diffusion may occur). The plastic deforms at least partially elastically to cooperate with the decompression of the gas pockets to restore the cup after pressure is released. The barrier wall need not be airtight, as long as it slows gas flow sufficiently to provide a low pressure within the vacuum cup relative to ambience, however gas permeability amounts to a loss of depressurization of the cup and requires more energy to evacuate to maintain a suction force.

Herein ‘suction cup’ is not limited to a material, shape or size, but rather to a manufactured structure functional to provide a barrier wall: for delimiting an interior of the cup from an exterior; that is compressible to permit sealing over a rough surface to separate the interior and exterior.

To ensure a seal on a rough surface, both of these types of suction cups typically rely on a lip thickness far larger than a mean diameter of craters/hills that form the roughness of the surface. Herein lip thickness refers to a mean extent of a meeting surface of a separating wall of the suction cup, in a direction that crosses the wall, as opposed to the direction in which the wall runs. A full width at half maximum of the mean profile of the wall can be used where the meeting surface is not as readily delineated, without discounting any hollow of the profile below the half maximum.

For example, open pore suction cups, provide higher compression rates and lower compression resistances, than closed pore suction cups of the same material. Thus an important concern for many applications, is how much force must be applied to press the cup into a seal, as well as how uniform the pressure distribution has to be across the seal, for vacuum actuation to engage or grasp initially to produce the attachment. The uniformity of the pressure is particularly important for drone perching or attachment; for grasping contact-sensitive bodies; and for grasping objects of complex geometry with less exact positioning, or greater variability of part geometry. While denser, thicker (typically rubber) seals can be used for heavier lifting applications if higher, more uniform, pressure can be applied before or during evacuation, these call for better controlled, uniform, pressing of the cup against the matching surface for good surface meeting load distribution, and objects that can withstand the force. The present invention may offer advantages for reducing this pressure and uniformity thereof.

Applicant finds only broad lipped, high compaction (crushable) suction cups exhibit satisfactory surface matching to enable adequate vacuum sealing over rough surfaces. However, the major downside to open pore suction cups is that to maintain the force, a high pressure vacuum must be continuously applied for as long as the grasping is required. As soon as the suction is removed, pressure begins to equilibrate given the porous nature of the cup. This also implies a higher energy cost per grasping operation, and one that varies substantially with the duration.

The following references present knowledge and incidentally related teachings in neighbouring fields. The use of 150-250 cps liquid or gel coatings in relation to solid rubber-type suction cups used for “vacuum fixers” is taught by U.S. Pat. No. 8,123,181 to Choi, WO2015072607 to Lee, and KR101062173 to Lee. Vacuum fixers are understood to be substantially permanent wall mounting features. Accordingly there would be no use for open pore suction cups in connection with these teachings.

KR101062173 to Lee uses a 0.5 to 4 mm thick coating of “soft synthetic resin or rubber material”, “a gel type made of polyurethane”, on a surface of an elastomeric suction cup to improve adhesion. As a gel can have very different flow properties than its constituent fluid (which may compose the vast majority of the gel), perhaps the 150-250 cps is the measure of the viscosity of the liquid phase of the gel and not the gel as a whole, as this range of viscosity is as runny as oil. A gel, as far as it behaves as a solid, does not have any measurable viscosity as far as Applicant understands in the present context. Applicant supposes that if the liquid phase of the gel comprises a resin that is curable in ambience, the liquid may cure in place to produce a durable polymer that would seal the vacuum fixer in place, adding to the permanence of the vacuum fixer.

Similarly, the WO publication to Lee and US publication to Choi teach a gel-type polyurethane with a “methylene diisocyanate diol compound . . . mixed in a ratio of 8 to 12 . . . having a viscosity of 150-250 cps”. The WO and US publications show the gel 118 below the “main frame 11” of the vacuum fixer, and generally surrounding a rubber membrane 111 used for sealing. The rubber membrane 111 is stated to be a “conventional suction member” in the shape of a disk composed of a “soft synthetic resin or rubber”.

Furthermore, U.S. Pat. No. 7,742,617 to Jeswine teaches a crawler (unmanned, self-propelled vehicle) with a gripper comprising a plurality of suction cups 54. Each suction cup may include 3 concentric lips that define inner cavities 128 for containing a “soft viscous material 124 such as silicone or other conventional rubber with a very low durometer value” that can be squeezed into contact with the surface 118 over which the crawler moves. The use of this soft material is “to promote the formation and maintenance of a seal with rough or grooved surfaces” (118). Viscosity is a property of a liquid, and durometer values are properties of solids. Thus this material 124 may be mischaracterized in being viscous (as a whole material), mischaracterized in having a durometer value (as a whole), or may not be a single-phase material (such as a gel). Furthermore, the material may be solid and “viscous”-ness may be a tactile surface property assessed by the author. Applicant notes the statement “soft viscous material may include fibrous material to increase the material's tensile strength”.

Thus it is known in the art to use gels or “fibre reinforced liquids” to promote adhesion in rubber lip (non-porous) seals of various kinds in vacuum fixers. None of these suggests use of an open pore cup material, and each suggests a very low viscosity.

Applicant's co-pending WO 2020/079668 teaches a base attachment module for a small weight unmanned aerial vehicle, the base attachment module having one or more suction cups, which may be of foam type or solid rubber type (including bellows-type cups of either construction). At this application teaches: “It will be appreciated that a trade-off between pliability and suppleness of the cups 15, elasticity/stiffness of the bonding, and longevity of the cup, can be chosen for different attachment problems. Furthermore, a tack or solid adhesive property of the material may be chosen with respect to an intended work surface (or variety of work surfaces). Furthermore a viscous liquid coating for the cup may be applied prior to departure, or may be expressed into the cup, onto a lip of the cup, or onto the surface, with a supply system, if adhesion to a widest range of work surfaces is required.”

Accordingly there is a need for improved vacuum gripping of rough surfaces, particularly of rough surfaces that have more complex or variable geometry, with reduced leakage across the vacuum barrier, to avoid the attendant increased power requirements for maintaining the grip. Furthermore, a need exists for improved vacuum gripping of rough surfaces with less, and less uniform, pressing force, and for improved grasping (forming of an initial seal of attachment quickly).

### SUMMARY OF THE INVENTION

Applicant has discovered that sealing of open pore suction cups can be substantially improved by application of an unctuous material, and has found remarkably low power consumption, enduring, grasping of surfaces, and grasp initiation with low pressing contact with the unctuous material. Herein ‘unctuous’ is not used to refer to oiliness (some unctuous materials, as the term is used herein, contain no substantial oil phase), but rather to a thickness or body of the material, with sufficient material density and surface tension, leading to surface barrier properties. An unctuous material has liquid-like deformation or flow-approximating properties, especially when subjected to shear forces, but preferably has enough resistance to flow to remain self-supporting in the absence of, or subject to low, shear forces. While solid-like and liquid-like properties are generally conflicting, there are some materials that exhibit limited properties of each. One example is the gel. Gels are typically composite materials having branched or linear supporting scaffold structures, typically of very fine members, and a liquid or gas trapped systematically by the scaffold. The liquid or gas, and its affinity with the scaffold, have a large impact on the mechanical response of the gel under load. The liquid or gas constitutes most of the volume, and often most of the weight, of the gel. These typically allow for microfluidic liquid motions to be observed at the interface on the small scale, but gels as a whole typically behave more as a solid, admitting of large scale elastic restorative forces. Most gels don't exhibit larger scale liquid-like response to deformation. All gels do not exhibit solidity or a very high viscosity (e.g. above 10⁴ centipoise) under low or no shear stress, and substantial flow akin to a material with viscosity below 10⁶ centipoise, when substantial shear stress is applied.

There are several non-Newtonian fluids that are potentially applicable, as well as some high viscosity Newtonian fluids. For example, latex or silicone caulk are high viscosity (substantially) Newtonian fluids (prior to cure) that have a consistency that admits of sealing, and can serve as an unctuous material. In general shear thinning (pseudoplastic) materials that exhibit non-Newtonian viscosity are inviting in that their resistance to motion decreases with increased stress. As such the material is stiffer when exposed to ambient pressure, but pressure on the unctuous material from contact with the rough surface, will apply shear stress, lowering fluid resistance. When the shear stress is reduced, the material thickens again. As such, the material will deform more readily and redistribute while the cup is being crushed, offering little resistance, and the material becomes more rigid once the crushing is complete, and will therefore stay in place to produce a better gas barrier.

Even more appealing are Bingham materials. These materials behave as if solid until a yield stress is exceeded, at which point they adopt a liquid behavior: the liquid behavior may be linear as with Bingham plastics, or may gradually decrease with shear rate (after shear stress is exceeded), as with Bingham pseudoplastics. For example, Bingham plastics such as toothpaste, mayonnaise, grease, and peanut butter have shear stress thresholds of 120, 150, 1000, and 1800 Pa, respectively.

Finally, time-dependent non-Newtonian fluids having viscosity that depends on history can also be used, such as thixotropic materials. While the specific behaviours of such materials are somewhat unusual, these materials are frequently quite stable, environmentally safe and innocuous, inexpensive and relatively abundant.

A particular material that has been found to have excellent properties is petroleum jelly, which is an example of a stabilized, macroscopically homogeneous mixture including at least one wax, and at least one oil. Also particularly relevant are mixtures and emulsions of fine solid powders (possibly also gas bubbles) in a liquid carrier, possibly with a solid wax phase. The liquid may be a polymer resin or rosin, in which case it can occupy a larger mass fraction, or may be a lower mass fraction of oil (similar to petroleum jellies). It is particularly preferable that any polymer resin or rosin, or prepolymer with cure retardant, content be minimized because it can be very difficult to preclude curing, even with abundant cure retardant, and punctilious observance of storage and handling procedures, as times between application and use of the unctuous material can vary. By avoiding use of polymerizable content, storage and handling procedures for the unctuous material can be non-stringent, and use cases can be indifferent to UV-exposure, temperature, humidity etc. Whether petroleum jelly (or other unctuous material) falls into any particular class of non-Newtonian fluid may be up for some discussion, however it is quite clearly non-Newtonian, and is an unctuous material.

Petroleum jellies tend to be insoluble in water, and therefore risk leaving a residue on surfaces, that may not be desired. Highly thickened water-based gels offer a substantial advantage in that 1—they may have high water mass fractions and therefore substantially evaporate in indoor and outdoor spaces, and 2—they are water soluble for easy cleanup in indoor spaces, and precipitation-based removal in outdoor spaces. Particularly sugar-based structures such as xanthan and guar gums are also environmentally friendly, non-toxic, thicken water to a very high degree (flow like behavior of liquids with 10⁴-10⁶ centipose viscosity), as well as being odorless, low cost and providing good seal enhancement and gas permeability retardant functions.

It should be noted that some non-Newtonian fluids are clearly inapplicable. While dry and wet powders frequently exhibit some properties of continuum mechanics that recommend them as non-Newtonian fluids, only fluids that achieve a modicum of gas impermeability will improve sealing of open-pore barrier walls. Thus unctuous materials have surface tensions of at least 10 dynes/cm, more preferably at least 50 dynes/cm.

To ensure that the vacuum gripper is reasonably well attached, it is desirable to ensure that the unctuous material has a high enough coefficient of friction, such as a static friction coefficient of at least 0.2. It will be noted that by applying the material only to sidewall surfaces of the porous cup, and not the lip edge (surface for meeting the rough surface), a material with inferior friction coefficient may not appreciably degrade friction resistance of the vacuum gripper, as a substantial normal force may be provided pressing the lip edge to the rough surface. Furthermore, it is desirable, whenever the unctuous material has a lower coefficient of friction than that of the lip of the suction cup, to apply the unctuous material, not as a coating of the cup, but rather to reduce the unctuous material on the lip.

Applicant has found particularly good grasping of rough surface with the unctuous material surrounding an outer wall of an open pore cup, where the unctuous material extends above the lip as a ridge around the cup. The ridge, and in general placement of the unctuous material on the outer wall near the lip, is preferable in applications where grasping is more important, whereas placement of the unctuous material on the outer wall of the cup between the base plate and half maximum is more critical for applications requiring a long duration of the surface gripping with the least energy applied to evacuate the inner volume of the cup (i.e. where leakage must be avoided). Applications requiring both are easily met by covering both and this is easy and efficient to apply. Quick grasping is particularly valuable when attaching drones to surfaces as it reduces the number of attempts to land or attach the drone.

Applicant notes that there are a great many possible desiderata for the unctuous material depending on the application. For many applications, a lack of visible marking of contact may be desired, and non-toxic, environmentally friendly compositions may be strongly preferred. In some applications visibility of the unctuous material on the cup may be desired for visual determination whether a vacuum gripper designed for many grasping operations is in need of reapplication or not, and in others reapplication is performed autonomously with feedback from a pump and/or on-board sensor. The unctuous material may desirably withstand precipitation, wind, and other varying climatic or other incidental interactions, or may be designed to be subjected to vibration, irradiation, extreme temperatures, or temperature fluctuations. In some applications the unctuous material may need to be chemically resistant or fire retardant.

Accordingly, a kit is provided for sealing a vacuum gripper, the kit comprising: a volume of at least 20 mL of an unctuous sealing material, the material exhibiting solidity, or a viscosity greater than 10⁴ centipoise when subjected to a shear force of less than 1 kPa, and exhibiting a viscosity less than 10⁶ centipoise under shear stress of 0.1 to 100 kPa; and at least one of: A) an applicator adapted to spread the material substantially exclusively over an outer side of a barrier wall of an open pore crushable suction cup, the applicator having a spreading surface 0.5-20 cm deep extending from a handle, and a loading area for retaining the material prior to spreading; and B) a suction cup with: an open pore crushable barrier wall mounted to a support, the wall in a relaxed pose: having a height of 0.5-20 cm, a lip thickness of 0.5-20 cm, that is 0.5 to 5 times the wall height; the support and wall surrounding an inner volume of the cup having a mean outer dimension extent of 3-200 cm and a periphery of 10-1500 cm; the support having a stiffness higher than that of the barrier wall such that a force applied on the barrier wall deflects the barrier wall more than the support; and a sealed pressure port supported by the support for controlled evacuation of the inner volume.

The applicator may be specifically adapted to spread the material over one of sides of the wall without covering the lip of the cup, whereby when the cup, with the material applied, comes into contact with a surface, some of the lip of the wall comes into contact with the surface without any of the material in between. The applicator may be specifically adapted to spread the material over one of the sides of the barrier wall to form a ridge that extends beyond a maximum height of the barrier wall. The applicator may further comprise a registration feature that aligns with a feature of a support of a suction cup for which use is intended, to facilitate manual alignment of the spreading surface and the outer side of the barrier wall.

The support may comprise a plate, for example of suitable metal or resilient plastic. The vacuum port may extend through the support into the inner volume. The support may have one or more cleats, barbs or spacers for contacting an object or surface. The support may comprises a mounting for a vacuum pump coupled to the vacuum port of the cup. The support may comprises a contracting type suction cup body with a lip to which the open pore crushable barrier wall is adhered. The contracting type suction cup body may comprise a telescoping mechanism, or a bellows type elastomeric suction cup body.

The material may be non-Newtonian fluid. It may exhibit pseudoplasticity, thixotropy, or a plastic yield limit stress, like a Bingham plastic or pseudoplastic. Or the material may be Newtonian. The material may have a static coefficient of friction of at least 0.08, and gas permeability below 0.2 liter per minute. The material may: have a lack of visible marking on contact with a preferred class of objects; have an identifiable visible marking on contact with a preferred class of objects; be non-toxic; be environmentally inert; be biodegradable; be visible on the edge of the suction cup; or be resistant to: vibration; irradiation; extreme temperature; temperature fluctuations; or a class of chemicals; or be inflammable. The material may be a stabilized, macroscopically homogeneous, mixture including at least one wax, or solid or ionic polymer component and at least one oil, or liquid polymer resin component. The solid, or ionic polymer component, or liquid polymer resin may be silicone based. The material may comprise partially refined petroleum jelly.

The cup may further comprise a portable pump adapted for coupling to the sealed pressure port. The pump may have a portable power supply, a pressure sensor coupled to the cup for determining a pressurization of the cup, and a controller for controlling the pump in response to the sensor. The cup may have one or more mounting surfaces for holding: the pump, a sensor, a loudspeaker, an audio recorder, a motion controlled platform, a laser, a light, a camera, an electronic circuit for processing data from the camera, recorder, or sensor, an electronic circuit for wireless communications, a motorized vehicle, or a mounting bracket. The kit may further include this held item.

The kit may be in assembled or disassembled form.

Also accordingly, a vacuum gripper is provided, the vacuum gripper comprising: a suction cup with an open pore crushable barrier wall extending from a support, the wall having a height of 0.5-20 cm, a lip thickness of 0.5-20 cm, that is 0.5 to 5 times the height, the wall and support surrounding an inner volume to define the cup, the barrier wall having a mean outer dimension extent of 3-800 cm, and a periphery of 10-1500 cm; and an unctuous sealing material sealing around an outer side of the barrier wall (preferably exclusively), the material exhibiting a solidity or viscosity greater than 10⁴ centipoise when subjected to shear forces of less than 1 kPa, and exhibiting a viscosity less than 106 centipoise under shear stress of 100 Pa or more.

The material's viscosity may decrease with increasing shear force. The material may have a non-zero yield shear strain, like a Bingham pseudoplastic. The yield shear strain may have a value between 10 Pa and 10 kPa, more preferably between 50 Pa and 5 kPa, and more preferably between 0.3 and 3 kPa. The viscosity under shear stress may be less than 3×10⁵ centipoise, and more preferably between 1 and 10⁴ centipoise.

The vacuum plate may be mounted to a vacuum source having an attachment feedback sensor whereby the vacuum gripper can autonomously regulate grasping of an object to which it is mounted.

A vacuum gripper for attachment to a rough surface is also accordingly provided, the vacuum gripper having an open pore crushable vacuum cup barrier, the barrier having: a lip with a height and thickness of 0.5-20 cm between inner and outer barrier surfaces, the lip thickness being 0.5 to 5 times the wall height, for meeting the rough surface; and a mean outer dimension extent of 3-200 cm and a periphery of 10-1500 cm; CHARACTERIZED IN THAT an unctuous sealing material is spread over the outer barrier surface that extends continuously to surround the vacuum cup, the material exhibiting a viscosity of at least 10⁴ centipoise when subjected to shear forces of 10 Pa to 1 kPa, and exhibiting a viscosity less than 10⁶ centipoise under shear stress of 10 kPa.

Finally, a method is provided for vacuum gripping a rough surface, the method comprising: providing a suction cup with an open pore crushable barrier wall extending from a support, the wall having a height of 0.5-20 cm, a lip thickness of 0.2-20 cm that is times the height, and the wall and support surrounding an inner volume to define the cup, the wall having a mean outer dimension extent of 3-800 cm, and a periphery of cm; applying an unctuous sealing material sealing around an outer side of the barrier wall (preferably exclusively), the material exhibiting solidity, or viscosity greater than 10⁴ centipoise, when subjected to shear forces of less than 1 kPa, and exhibiting a viscosity less than 10⁶ centipoise under shear stress of 100 Pa or more; and placing the suction cup against the rough surface while drawing a vacuum on the inner volume, so that the wall crushes, the material seals the cup, and the support approaches the rough surface.

Applying the material may comprise spreading the material on the outer side so that in a crushed, evacuated pose, the material is distributed over the outer side with enough uniformity so that at least 1 mm of the material is provided as a minimum, and a thickness of the material varies by less than 4 mm across the outer side surface, with less than 10% of the material on an inner side or meeting surface of the wall. Applying the material may comprise forming a ridge of the material continuously around the wall, the ridge extending from the outer side of the wall and extending away from the support higher than a meeting surface of the wall.

The method may further comprise mounting the suction cup to a moving platform, and placing the suction cup vacuum gripper comprises operating the moving platform. The moving platform may be a crawling, rolling, flying, hovering, or floating vehicle; or a kinematic machine.

The suction cup may be coupled to a pump with a portable power supply, a mechanical grip, a controller, and a sensor to define an autonomous system for maintaining attachment of a body to a rough wall of a structure via the grip, where the controller is adapted to receive a signal indicating a loss of depressurization of the cup, and triggers activation of the pump to maintain attachment.

A copy of the claims are incorporated herein by reference. Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a photograph showing a particular embodiment of a prior art vacuum gripper in the form of a base attachment module having 3 crushable open-pore suction cups at three respective extremities surrounding an open-pore suction cup on a centrally positioned bellows-type contacting suction cup;

FIGS. 2,2A are front and side views, respectively, of a first embodiment of vacuum gripper in accordance with the present invention, the first embodiment comprising a suction cup with an unctuous sealing material surrounding an outer edge thereof;

FIGS. 3A,B schematically illustrate two containers of unctuous sealing material, with an applicator as used in some kits in accordance with the present invention;

FIGS. 4A-D are four partial illustrations schematically showing alternative distributions of the material on an internal or external side wall of a thin section of the suction cup, in accordance with embodiments of the present invention, A showing an upper wall covering, B showing a lower wall covering, C showing a substantially whole of side wall covering and D showing a ridge formed;

FIGS. 5A,B are schematic side views illustrating two contracting type suction cups providing alternative forms for the suction cup of FIGS. 2,2A;

FIG. 5C is a front view of a gripper with many integrated suction cups integrated into a pad;

FIGS. 6A-C are three time steps illustrating principal steps in deforming a wall 15 of a vacuum gripper to form a seal with the unctuous material;

FIGS. 7A-D are four time steps illustrating first contact of the unctuous material with ridge-formed material to form a temporary high force adhesion to a rough surface, then its gradual deformation to the complete contact of the open-pore suction cups;

FIG. 8 schematically illustrates an autonomous vacuum gripper formed with a bellows-type contracting suction cup with the material applied, and a pump with an internal controller, integrated power supply, a sensor, and an actuable mechanical grip for holding a body to an attached, rough surface;

FIG. 9 schematically illustrates a BAM in accordance with the present invention, the BAM being an autonomous vacuum gripper having a plurality of suction cups, a pump with internal control, and a docking mechanism for attachment to a vehicle;

FIG. 9A schematically illustrates the BAM docked to a small aerial vehicle;

FIG. 9B schematically illustrates an alternative BAM for mounting a robotic arm;

FIGS. 10A,B are photographs showing suction cups, respectively with unctuous material applied only on the outer side wall, and forming a ridge;

FIG. 10C is a photograph of a rubber suction cup with unctuous material around the lip thereof for comparison;

FIGS. 10D,E,F are photographs of the cups of FIGS. 10A,B, attached to four exemplary rough surfaces;

FIG. 11 is a photograph of a drone attached to a rough concrete wall with a BAM of FIG. 9, thus producing an autonomous semi-permanent mounting system; and

FIG. 12 is a photograph of a prototype BAM for a lighter weight drone having a single suction cup vacuum gripper.

### DESCRIPTION OF PREFERRED EMBODIMENTS

Herein a vacuum gripper, and a kit for forming same, is disclosed, the vacuum gripper uniquely adapted to providing a better seal, and therefore requiring less energy for maintaining attachment force for a temporary mounting or attachment to a rough surface. The vacuum gripper is composed of a crushable, open-pore suction cup, such as those well known in the art. The application of an unctuous sealing material surrounding a sidewall of the cup, has a surprising result of greatly enabling a vacuum seal using low cost and low energy equipment. As will be explained in the examples section hereinbelow, without the unctuous sealing material, a high pressure pump is required to maintain a vacuum seal of a rubber or open-pore suction cup to a rough surface, such as painted concrete, unpainted concrete, or other mineral-compacts, even if the cup is to carry a nominal weight such as under 40 kg on a perpendicular face. With a suitable unctuous material provided around the sidewall, light, portable, powered pumps can be used intermittently to re-depressurize the cup, allowing for a portable, reusable, reliable temporary mounting structure, or grasping mechanism.

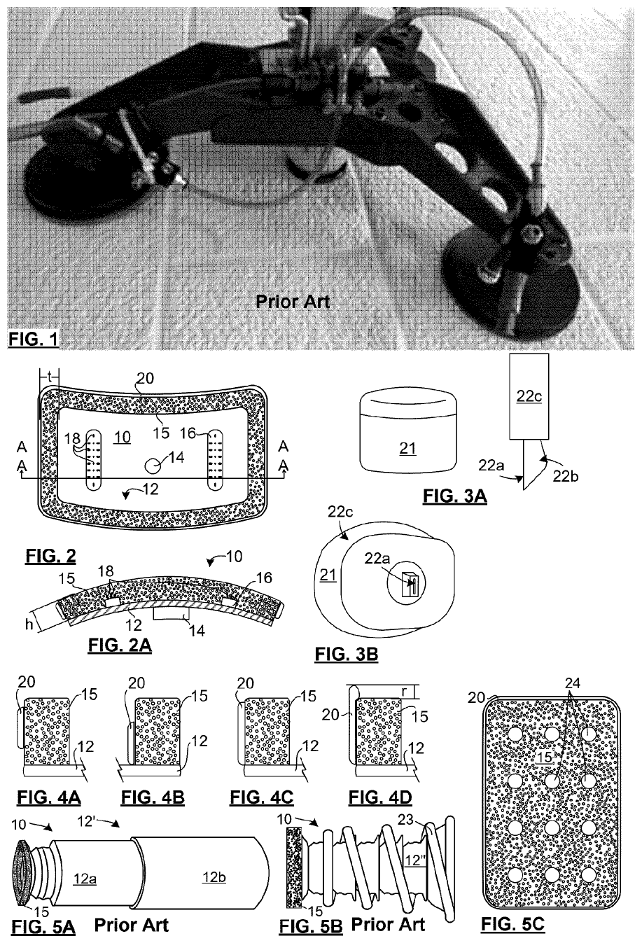

FIG. 1 is a photograph of base attachment module (BAM) known in the art from Applicant's co-pending WO 2020/079668, the entire contents of which are incorporated herein by reference. The BAM has a wye frame with three large surface area, open-pore foam, suction cups at each of the three members extending from a hub. The hub features a fourth, bellows-type contacting suction cup at the centre of the three cups. The BAM is shown attached to a vertical wall of painted concrete, which is an example of a rough surface.

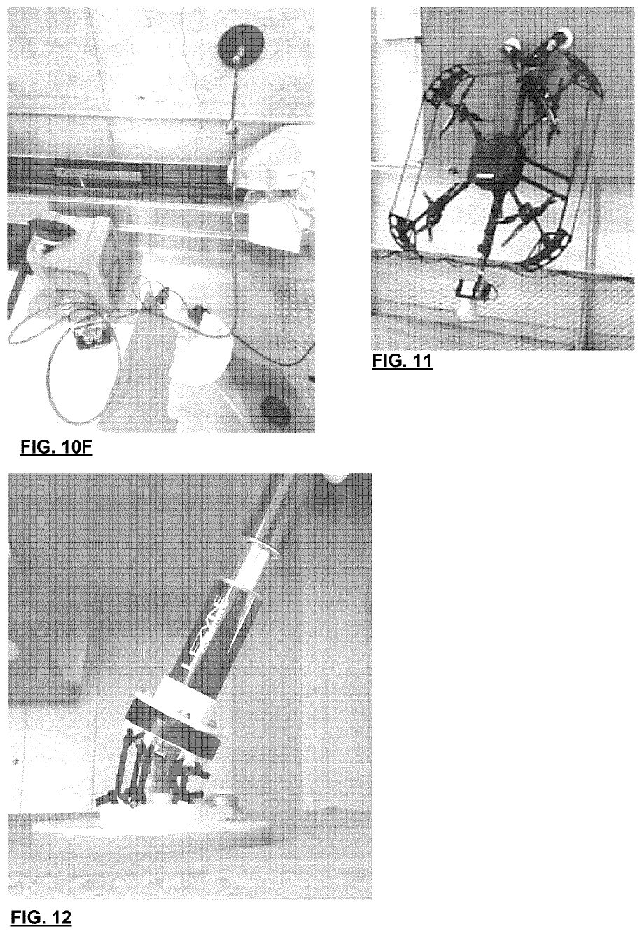

FIG. 2, and FIG. 2A, are front and side views of a schematic illustration of a vacuum gripper 10 in accordance with an embodiment of the present invention. The vacuum gripper 10 is composed of a vacuum plate 12, having a vacuum port 14 therethrough, and a crushable open-pore wall 15 adhered to the plate 12 around a periphery thereof, to enclose an interior of a cup. As shown, the plate 12 further has a set of cleats 16 extending therefrom used for registering the vacuum gripper 10 against the rough surface for which it is intended. Cleats are understood to be relatively rigid materials for contacting the surfaces, although other spacers may be used that can deform, including additional spacers composed of segments of the same material as the wall 15, as shown in FIG. 10A.

The plate 12 is provided as a support for the wall 15 and cleats 16. While the vacuum port 14 could, in principle extend through the wall 15, or between an interface between the wall and plate 12, a more robust sealing enclosure extends through the plate, which preferably has a stiffness at least 10× (more preferably 100×) greater than that of the wall, in that a force applied on the gripper 10 via the wall 15, especially for an intended surface, will deflect the wall a distance d that is at least 10× the deflection of the plate. The plate 12 may be of a metal, metal matrix composite, or alloy, or a rigid polymer, as is well known in the art. The plate 12 shown is a rectangular piece with rounded corners (FIG. 2) of uniform shallow curvature (FIG. 2A) in that the radius of curvature is far greater than dimensions of the plate 12, and accordingly the gripper 10 is well designed for attachment to an interior of a cylinder of complementarily curved pipeworks. Naturally a wide range of other shapes of vacuum plates 12 can be used, although circular, elliptical, rectangular and square are the most common plate periphery shapes, and flat, singly curved of constant curvature in one direction, bicurved (such as a generally hollowed form providing a deepest recess of the cup near a centre of the cup) are common.

There is much variability of the inner shape and content of vacuum cups. The additions of cleats 16 are particularly beneficial to increase friction, and stiffness of the attachment, particularly if the top surfaces of the cleats are selected for this function. For reliable operation, the cleats are valuable if the rough surface to be grasped has a large-scale bulk shape that is well characterized to match the gripper 10. Many surfaces, such as building walls, are primarily flat, and cylindrical and spherical shapes have the beneficial property of having a same contour at any location, which is useful for designing general purpose vacuum grippers. Less prevalent structures for gripping may have surfaces that are irregularly shaped, such as a cone, or more complicated shapes, which may have limits on a number of positions and orientations at which a vacuum gripper 10 can be attached, and these may require a smaller cup size so that across the area the rough surface sufficiently approximates the shape of the gripper 10.

The wall has height h and lip thickness t, both measured unstressed (i.e. under STP). Such cups are composed of typically foamed polymers and like sponge materials. The wall is highly crushable: under nominal forces experienced by a vacuum cup, it may exhibit a mean height of 0.01× h to 0.6×h, more preferably of 0.1×h to 0.4×h. While h is easily measured in the illustrated examples, the wall 15 need not have a rectangular cross-section (as shown in view 2A). It is known for porous suction cups to have cambered or rounded lips, or to have other profiles. If the profile is complex, h can be taken to be the mean height between the furthest separated half maxima.

The wall 15 preferably has a low aspect ratio: preferably t:h is from 1:2 to 4:1; and preferably t less than 1/32, and more than 1/100, of an outer perimeter of the wall.

Furthermore, barbs 18 can be used to increase engagement with the rough surface. Barbs and or cleats are both helpful if a friction of attachment is reduced by the use of the material. Barbs 18 are typically a set of wires (branched, or linear as shown) that penetrate crevasses and bend to form a resilient connection that collectively increase a resistance to relative motion, especially in a transverse direction. Barbs are well known as attachment mechanisms themselves for micro-UAV systems, and their critical parameters are stiffness of the wires, length of the wires, angle of orientation with respect to the surface, and speed of contact, and their effect varies widely with a hardness, porosity and variability of the rough surface. It will be appreciated by those skilled in the art that the barbs 18 shown are grossly exaggerated in thickness, to ensure visibility.

The cleats 14 shown have barbs 18 extending from a top surface thereof (only 3 of which identified for ease of illustration), which is beneficial if variability of the rough surface does not allow for an expected strict registration of the cleats 16. If registration of the cleats 16 is expected, it is preferable for the barbs 18 to be located away from the meeting surfaces of the cleats.

The vacuum gripper 10 has an unctuous material 20 disposed around an outer side of the wall 15. The material 20 is spreadable, and is unctuous as the term is used herein. The unctuous material is reasonably gas impermeable, and has, at least under some conditions, a viscosity less than 10⁶ centipoise, and under some conditions at least, a viscosity greater than 10⁴ centipoise. The material 20 may be Newtonian liquid, with a constant viscosity (as a function of intended use temperature) within this range, or it may be a thixotropic, or Bingham material, as described hereinabove. In general the material has a viscosity less than 10⁶ centipoise during contact with the rough surface, when a shear load is applied to it, for example when subject to a shear force of 100 Pa to 100 kPa, and has the viscosity greater than 10⁴ centipoise, when under no, or substantially no shear load, such as when subjected to a shear force of less than 1 kPa. The unctuous material 20 may be self-supporting under low shear force, and therefore amenable to forming ridges.

FIG. 3A schematically illustrates a container 21 for the unctuous material 20, and an applicator 22 in the form of a blade or wiper for applying the unctuous material 20 onto an intended open-pore wall 15. The applicator 22 has a spreading surface 22a, a loading area 22b for holding the material 20 prior to spreading, and a handle 22c for manipulating the applicator 22. The spreading surface 22a has a length that corresponds with h, whereby the applicator, once loaded with the material, can spread the material over the outer side of wall 15 of the intended gripper 10. Preferably, a tip of the applicator has a meeting surface that matches a guiding feature of the cup (preferably on the plate 12) to encourage manual deposition to a uniform thickness. Preferably the handle is ergonomic. In some embodiments the application is provided by rotating the cup with respect to the applicator 22, while tilting the loading area 22b to supply the material to the sidewall.

Herein variants of an embodiment are provided with reference numbers that correspond with like or similar features of the embodiment. Use of the same reference numeral indicates that the features correspond and the descriptions of the corresponding features are not generally repeated herein. Features that vary in different variants can be assumed to be combinable with other variants to produce alternative embodiments that are equally intended in this disclosure.

FIG. 3B is an alternative means to FIG. 3A for kitting the unctuous material 20. The container's 21 internal area provides the loading area (not in view), and is squeezable about its body to express the material through a nozzle. The body of the container therefore is compressible and forms a handle 22c for manipulating the applicator 22. The nozzle delimits a spreading surface 22a. As is well known in the art, thixotropic, shear thinning, and Bingham materials in particular, are frequently dispensed by taking advantage of shear thinning or pressure induced increase in flowability of such materials. The nozzle dimensions (length and thickness) are chosen for controlled dispensation, and the length is particularly chosen to match a desired bead to be deposited onto the wall 15. Higher viscosity or effective viscosity materials may be applied by increasing the pressure by providing stiffer packaging materials, rolling a tube, or expressing with a plunger as a caulking gun. A tip of the nozzle may be designed with a guiding feature for improving reliability of deposition according to a desired distribution.

FIGS. 4A-D are four examples of distributions of the material on a thin cross-section of a wall 15, each having advantages in respective applications. As each cup will have a substantial decrease in height h when compressed against a rough surface with a given vacuum pressure differential, it is easy to determine what necessary fraction of the wall 15 needs to be covered on the side wall for complete coverage of the side wall once a desired compression is achieved. The side wall may be designed to be completely covered, for example, at any degree of compression, or within any range of degrees of compression of the wall 15, such as a range between 20% and 55%. A sealing of the porous wall 15 is only effective once this much compression is complete. Furthermore, the material may preferably be of a minimum thickness to ensure low gas permeability, which may be used to establish bead or distribution dimensions.

FIG. 4A shows a bead of the material 20 deposited nearer the lip than a base of the wall 15. The bead has a substantially constant thickness away from its ends, and, in this illustration, covers about 60% of the side wall. If the lip of the cup is used to direct the deposition of the bead, it can be easy to design an applicator for any cup having a h greater than a provisioned value. As long as the bead height is greater than a compacted height of the wall in use, this same applicator can be used for a wide array of cups.

FIG. 4B shows a bead deposited nearer a base of the wall 15. It will be appreciated that using a supporting part of the cup, such as plate 12, as a reference for controlling deposition of the bead can be advantageous, as the plate 12 is far more stiff. A single applicator can be again designed for a range of cups, as only the plate 12 is a reference surface. With the material disposed here, prior to seal establishment, more of the airflow is directed around the lip of the cup, as less airflow is provided through the wall near its base, which may be advantageous. Furthermore, with this distribution, less of the material will come into contact with the rough surface, and thus 1—marking of the surface, and 2—loss of the material from the gripper, may be reduced.

It will be noted that FIG. 4B shows deposition on an inner side of wall 12, as opposed to the outer side used in FIGS. 4A,C,D. If the seal is provided on the inner side of the barrier wall 15, evacuation of the chamber does not induce a crushing of the wall directly, but only through the meeting rough surface. The air initially trapped within the chamber is not vented through port 14, but rather gets expelled to ambience. This air is a small volume, relative to the chamber, for most cups, and may not make a substantial difference in evacuation time or energy required to make a seal. A risk that the material 20 makes its way into a vacuum port 14 and occludes or constricts it, especially if the material is has a viscosity on the low end of acceptable has been found to be generally not worth taking. The application of the vacuum gripper is expected to see substantial jerks or accelerations between deployments against the rough surface(s). While thicker, waxier, unctuous materials are less likely to run into the vacuum port 14, the risk of occlusion with these materials is higher if ingested.

FIG. 4C shows a deposition with the material 20 substantially covering the outer edge of the wall 15. The side wall approaching the lip is the only bare section. This is preferred if the objective is to reduce an amount of the material 20 lost in contact with the rough surface. Regardless of how the material is first applied, it may end up looking somewhat like this after several iterations of vacuum gripping and release. With this deposition pattern, the least movement of the material is provided during compression, and a best seal is obtained from the beginning of engagement with the rough surface. The applicator 22 may use a back face of the plate 12 for registration purposes.

FIG. 4D shows a ridge formed of the material 20 above the lip, extending a ridge height r<3 cm (more preferably 1.5, 1, or 0.7 cm) depending on a viscosity or stiffness of the material above the lip. Ridge height r is typically less than ½ h and ½ t. Preferably a volume of the material 20 extending above the lip is less than sufficient to cover the lip surface, especially if the material decreases a friction between the rough surface and the gripper; or the material has a stronger affinity for wetting the rough surface than for wetting the wall 15. Petroleum jellies of various purity and composition, and mixtures of petroleum jellies with powder, may decrease friction, but otherwise work well, and thus are beneficially provided in a manner that does not risk covering the lip.

The material 20 in this embodiment improves a seal by presenting a plastically deformable, gas-impermeable ridge for meeting the surface, while still providing the advantage of covering the crushable open-pore barrier wall 15 with an effective seal.

FIGS. 5A-C schematically illustrate three variants of the vacuum gripper 10. Many vacuum grippers consist of an array of cups mounted on a frame, and the grippers shown have only a single cup, as is the minimal case. It is deemed trivial to gang a plurality of cups to a common load bearing frame. FIGS. 5A,B show contracting-type suction cups, prior to application of the material 20.

FIG. 5A shows a variant where the plate 12 is replaced with a support structure with a telescoping frame 12′. Internal to the telescoping frame 12′ is a linear actuator for reciprocating a moving end 12a thereof relative to a base end 12b thereof. The cup defined by the crushable open-pore barrier wall 15 is disposed at the moving end 12a, and the interior of the cup may comprise a volume that depends on state of extension of the actuator, in that the volume of the cup expands as the telescoping frame 12′ opens.

If the interior volume of the cup is adequately sealed, suction may be effected by contacting the lip against the rough surface in a compact state, and then extending the linear actuator to increase a volume of the cup under the seal, as this may greatly increase suction power if only a limited vacuum power is supplied locally by a pump. The increased suction power is supplied exactly when needed, to grasp the rough surface, and is not available to maintain the attachment. Thus a relatively under-powered pump can be used to continually maintain the attachment, without having to provide an initial grasping force which may be substantially higher.

Alternatively, the cup can be in a somewhat relaxed, extended state when contact is made. An advantage of this grasping scenario is provided when a bumper is desired to absorb an impact with the surface. Once the suction contact is made, the actuator is operated to pull the surface towards the plate 12, crushing the wall 15, while the vacuum is drawn to more than compensate for the increased pressure in the cup that arises from any contraction of the volume (depending on the structure of the moving end 12a, there may be no appreciable change in volume).

If the volume of the cup can change substantially with actuation position of the moving end 12a, the linear actuator may be calibrated to ascertain the state of depressurization of the interior, which can be fed back to a controller of the pump. The actuator can be used to increase speed of suction grasping, release the vacuum gripper when desired, facilitate delivery of the grasper to the rough surface, or to manipulate the frame with respect to the surface, e.g. to tilt a sensor or applicator mounted thereto.

FIG. 5B schematically illustrates a somewhat simpler device than that of FIG. 5A. Instead of a linear actuator, a spring 23 is provided, and instead of a telescoping frame, the wall 15 is joined to a bellows-type suction cup 12″ that is supported by the spring 23. The spring 23 is shown as a helicoidal spring, having a larger diameter at the base end, and narrower diameter towards the wall 15, so as to allow nesting of the spring, and higher stiffness resiliences in pitch and yaw. The bellows-type suction cup 12″ (one class of contracting type suction cups), which may be formed of a resilient rubber, with the spring 23, has a stiffness substantially higher than the crushable open-pore wall 15. A latch (not in view) for releasing the spring 23 may be manually set and released in operation, for example it may be mechanically released if a uniform pressure of a threshold magnitude is presented across the wall 15. Once again the volume of the suction cup is greatly enlarged compared with the cup of FIG. 2, and this increase in volume variability can be used either to increase suction (possibly obviating the need for any pump—particularly if fine control over the position and orientation of the vacuum gripper relative to the rough surface is enabled), or to project the cups forward from a base structure. A second spring on an interior of the bellows type contracting suction cup 12″ may counteract the spring 23 for improved force control as a function of extension.

FIG. 5C is a further variant of the vacuum gripper 10, having a form more commonly used for picking up cardboard surfaces. The vacuum plate 12 has numerous, perforations 24 (only 3 identified for clarity of illustration). The perforations 24 couple the face in view with a plenum that aggregates the perforations, and communicates with one or more vacuum ports (not in view). A bead of unctuous material 20 is provided around the outer edge of the barrier wall 15. An advantage of such a structure is that each perforation 24 acts, in a limited capacity (because of constricted air flow paths between the perforations 24), as an independent suction cup, and can draw initial contact with the rough surface.

Seals produced by unctuous materials has been demonstrated to make it possible for a lightweight, portable, powered pump to maintain a substantial attachment force using these cups on rough surfaces, as opposed to higher power pumps tethered by their electric supplies. Lower power actuation with a longer attachment time, and possibly higher attachment force are made possible with the use of unctuous material.

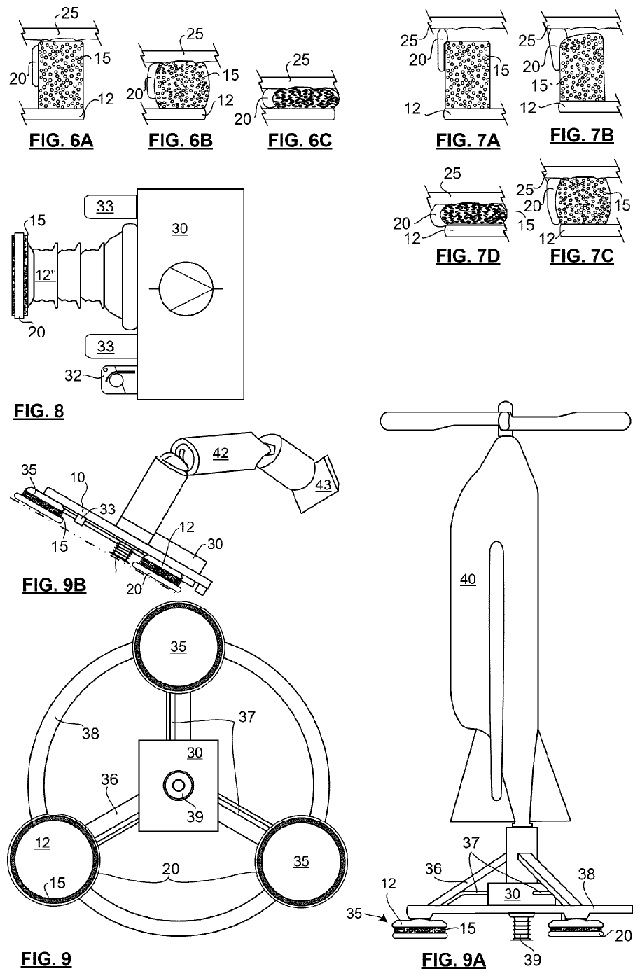

FIGS. 6A-C illustrate deformation of a thin cross-section of a barrier wall 15 throughout an exemplary attachment process. It will be appreciated by those skilled in the art that the material 20, and wall will deform, bulge, slide and relocate during compression in various ways depending on viscosity of the material, and may depend on the porosity of the wall, contact angle and hysteresis, force of the deformation and strain rate. The wall 15 itself tends to collapse instead of displacing, because of its porosity. As such the following is merely a schematic illustration.

As seen from FIG. 6A, the wall 15 is loaded as per FIG. 4A, and is brought into contact with rough surface 25. Either before the contact is made, or after a sufficient pressure is applied to the wall 15, the vacuum port is depressurized, tending to draw the rough surface 25 into contact with the vacuum gripper 10. Thus, by a push of the vacuum gripper towards the rough surface, by the vacuum drawing of the two together, or both, the rough surface presses against the lip of the wall 15. After an initial conformation of the lip to the rough surface, the pressure is uniformly borne across the lip (this would be at less than 10% compression). In the illustrated example the material 20 will not come into contact with the rough surface before substantial conformation of the lip occurs. Once the material comes into contact with the rough surface, the wall may be 15-20% compressed. By FIG. 6B the rough surface 25 has compressed the wall 15 to about ⅔ h, and the material 20, which deforms less readily than the wall 15, covers an increasingly large fraction of the side wall. The bulging of the wall is exaggerated in this view for illustration, as much of the compression occurs by collapse of the pores. Solid-like stiffness or high viscosity results in some downward movement of the bead with respect to the wall. By this juncture, depending on the strain rate, the wall may be substantially uniformly compressed. By FIG. 6C, the wall is about 70% compressed, and the material extends between the plate 12 and rough surface 25. While air pockets may be present between the material and wall 15, depressurization of the cup will remove this as the air is pulled through the wall. A thick, relatively uniform thickness material therefore surrounds the wall rendering the porous wall, with the material, a relatively gas impervious, sealed barrier wall. The material has a thickness and body sufficient to hold itself up in the absence of shear forces, and is unable to tunnel through the wall as a result, even under vacuum load.

FIGS. 7A-D schematically illustrate principal steps in an exemplary attachment process with the material applied as a ridge. FIG. 7A shows the rough surface 25 meeting the material 20 prior to contact with the lip of the wall 15. Once the contact of the ridge is made all around the cup, there is a partial closure of the cup, as the only breach in the seal exists through the wall about the bottom half. Flow resistance through the wall may be substantially higher than through a gap between the lip and rough surface, and this alone affords a depressurization chamber to build up as air is removed from the interior faster than it can through the limited open section of the wall.

As the material 20 has a higher stiffness than the wall, pressing the rough surface against the lip causes the wall to locally compress. As shown in FIG. 7B, the material is pushed towards the base, and deforms in proportion to a resistance to the movement over the open pore material. By the time step shown in FIG. 7B, the material covers half the outer side wall and contact with a less-deformed inner radial edge of the lip is imminent. By FIG. 7C, the material nearly covers the outer side wall, which is compressed to about ⅔ h. By FIG. 7D, the material completely covers the wall, which is compressed to about 0.3 h.

Applicant has demonstrated improved grasping of surfaces, with less time, contact pressure, uniformity of contact pressure, and less accurate placement using ridge-formed material.

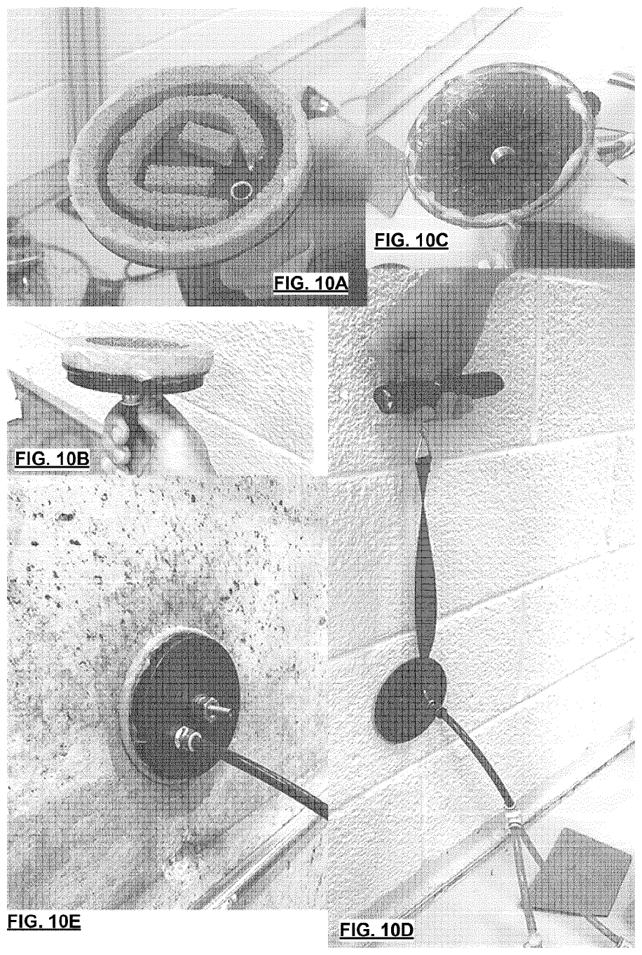

The vacuum gripper with the highly deformable wall and material together allows for better retention of depressurization within the cup, or a better seal. This makes it possible for the gripper to maintain the adhesion for longer intervals between depressurization, or for lower power pumps to be used continuously to maintain attachment. While cups with controlled volume, such as contracting type suction cups of FIGS. 5A,B may provide adhesion for a period of time without any further power supply, for many applications this time may not be long enough, the attachment force may not be strong enough, or monitoring of the attachment force may not be feasible. Thus for many applications, the vacuum gripper 10 preferably includes a lightweight, portable pump 30 with an on-board power source (renewable or not) and a controller, as schematically illustrated in FIG. 8. Autonomous vacuum gripper 10 may have a wireless communications circuit in communication with, or integrated with, the controller. As such, the vacuum gripper 10 is an autonomous device, adapted to be mounted to a rough surface, and to maintain adhesion to the rough surface for a longer duration than prior art vacuum fixers or like devices, and can hold mounted thereto higher loads.

FIG. 8 shows a gripper further comprising a mechanical latch 32, consisting of a catch arm hingedly mounted to a base, and linear actuator with a curved arm for releasing a gravitationally loaded device from an eyelet surrounded by the catch arm and base. A set of bumpers 33 provide for registration of the gripper to a vertical rough surface, while ensuring clear space for release of the latch 32. A low-weight, low power pressure sensor provided in the bumpers may provide a feedback signal to determine current pressurization state of the cup.

The application for the vacuum gripper may not involve a releasable latch. Instead the vacuum gripper 10 may include an optical, electromagnetic, electric, magnetic, mechanical, chemical, or acoustic sensor or emitter, or one or more arrays of such sensors or emitters, the gripper can be deployed in numerous applications for different purposes.

While FIG. 8 shows a single suction cup, as may be preferable for inconspicuous, low-size and weight devices, it will be appreciated by those of skill in the art that a larger number and spatial distribution of the cups on a gripper can greatly increase a load bearing capacity, and stability.

FIG. 9 schematically illustrates a BAM like FIG. 1 having three cups 35 each formed with a respective vacuum plate 12 and a barrier wall 15 extending therefrom, the three cups 35 located on ends of spokes of a wye frame 36 further supported by a hoop 38. A contracting type suction cup 39 is provided at a hub centre of the BAM, underneath pump 30. Pressure supplies 37 (see also FIG. 9A) from each cup 35 meet a plenum enclosed in the pump 30, so that operation of the pump 30 controls all the cups in unison. Alternatively a set of switches, such as solenoid valves, in each supply line 37, is controlled by the controller to select cups 35 and 39 to address depressurizing flow.

FIG. 9A shows the BAM of FIG. 9 mounted on a tail-sitter drone. While this type of BAM has been applied to multi-copter style small UAVs, it is clearly equally applicable to tail-sitters and a wide variety of UAV designs suited to different purposes. For example, tail-sitters, and other VTOL-capable UAVs generally have a larger range as gained by aerodynamic lift in horizontal flight, compared with copter-style UAVs that have greater stability at lower wind speeds, and faster redirection response times. FIG. 9A offers a side elevation view of the BAM.

While a BAM may be designed to be deployed to a surface by a UAV, or may be a landing base for a UAV, especially a hover-capable UAV. There are a variety of techniques known in the art for catching a dangling part to facilitate a registered landing of UAVs to docking stations, each with attendant hardware and equipment that could be mounted to the base. The BAM can also be permanent landing gear for the UAV.

Alternatively, or additionally, the BAM may provide a structure for mounting to a robotic arm 42, as shown in FIG. 9B. The BAM may have remarkable stiffness, especially with the use of bumpers 33 (inside and/or outside the cups 35), and this stiffness can stabilize robots to a higher degree, allowing for improved accuracy. The BAM is designed slightly differently from that of FIGS. 9,9A, in that the wye structure is limited to a plane, and the bumpers 33 are provided on the hoop at angles from the hub intermediate the cups 35. The robot 42 has a base attached to the hub adjacent the pump 30. The pump 30 has a bottom wall positioned intermediate the hoop 38 and the meeting surface of the bumper 33. The robot 42 happens to illustrate 3 joints and a generic, schematically illustrated, end effector 43. End effectors 43 known in the art are, or can be, adapted to perform each of the processes identified in WO 2020/079668.

### EXAMPLES

A first campaign was performed to demonstrate attachment of a vacuum gripper to a painted, rough wall of concrete block, with an open pore foam suction cup. While these suction cups may be known to be used in the concrete handling industry albeit with much more powerful vacuum pumps, it is surprising the degree to which vacuum power can be reduced with the unctuous material. Specifically, the foam material used is an orange foam obtained by the expansion of a natural rubber, from Vuototechnica S.r.l (model number 08 127 15 OF) and the vacuum pump used for the experiment was Airpon MODEL D2028, 12 v, 12 LPM Freeflow, 16 inHg (˜54.2 kPa) nominal. The foam material (identified as OF GERANIUM™) was bonded to a vacuum plate composed of anodized Al, with a vacuum port machined therein. The plate was a disk having a thickness of 15 mm and a diameter of 127 mm. The foam had an unstressed thickness of 15 mm and a width of 17.5 mm. The cup weighed 0.49 kg. Other vacuum grippers were formed with similar cups and foam materials.

FIGS. 10A,B show two such cups, FIG. 10C shows a rubber cup coated with petroleum jelly and used for comparison, and FIGS. 10D,E,F show test campaigns against a painted concrete block wall, a first porous concrete wall, a second porous concrete wall, and a cinder block.

The vacuum gripper was pressed against the vertical walls with an initial pressure of 50 N, and the vacuum was drawn to ˜54.2 kPa. The produced vacuum gripper held up on the vertical wall, against gravity, for about 5 seconds after the pump stopped, before falling to the ground.

The same vacuum gripper was coated completely on the outer edge, inner edge and meeting surface. Specifically the coating was approximately 1-3 mm thick, and as uniform as can be expected with manual application. The coating was commercial petroleum jelly on an open pore crushable wall of the suction cup. The coated vacuum gripper was pressed to the surface with a force of 20 N, a vacuum of ˜67.7 kPa was reached. During the cup depressurization, the cup reached a constant vacuum level within about 15 s, indicating a good seal, and less air leakage.

In subsequent trials, different distributions of the petroleum jelly were applied to the vacuum gripper. When the petroleum jelly was placed on the meeting surface (lip), the vacuum seal is in no way impaired, and the normal force is as good or better, but the vacuum gripper a noticeably lower friction with the wall. In some cases, the vacuum gripper was seen slipping down the wall, when loaded, while maintaining the vacuum grip. While this is clearly undesirable for some applications, in others it may be of benefit to be able to slide the vacuum gripper relative to the gripped surface, while maintaining substantial normal force via suction.

It was also observed that when the petroleum jelly was placed on the inner foam wall of the vacuum gripper, air leaks were greater in that a duration of pump activation required to achieve constant vacuum level was longer. This is understood to be a result of the lack of forces tending to distribute the unctuous material over the surface, when the loading is initially on the interior surface of the wall. Petroleum jelly tended to flow toward air outlet (vacuum tube connection), risking pump clogging.

Finally, when placed exclusively on the outer foam wall of the suction cup, air leaks are very small, in that it took 10-15 s for the pump to achieve constant vacuum level, and horizontal friction on the rough surface is still high enough to hold a weight on a vertical surface. Moreover, when petroleum jelly, spread on the foam outer wall, protrudes from the meeting surface of the cup, it defines a continuous deformable lip or ridge, with demonstrably improved sealing behavior in that vacuum initiates with a low contact force and appears to be instantaneous. A force required to make the seal to draw the surface and the gripper together, is greatly reduced.

A second campaign of experiments was performed to validate usage of vacuum cups sealed with petroleum jelly to attach our Base Attachment Module (BAM) on rough surfaces. Materials used in this experiment were the same BAM frame demonstrated in 200 lbs resistance test in co-pending WO 2020/079668; 3 vacuum cups Vuototechnica S.r.l (model number 08 127 15 OF); and one bellows type suction cup in BAM's central position (PIAB G.FLI70F.B1.S1.NT18M.0, 70 mm outer diameter and long-wearing natural foam rubber lip that is free from silicone). All four vacuum cups were covered exclusively on their outer wall with commercial petroleum jelly. And finally, vacuum was generated to these four suction cups by four venturi vacuum pumps (PIAB Pi12-3, fed with compressed air @90 psi). Later experiments demonstrated that a venturi pump can be replaced by a small electric vacuum pump (Airpon MODEL D2028, 12 v, 12 LPM Freeflow, 16 inHg (˜54.2 kPa)) with comparable performance for this application. The BAM assembled with this material configuration was activated to grip the vertical surface. We successfully tested the painted rough concrete-block wall and unpainted foundation wall that had many visible concrete molding air bubbles and cracks. In each case, a payload of 40 lbs was supported confidently for a long period.

Further testing campaigns were performed to test various unctuous materials, to see if we get similar results and if we could generalize our approach to improving vacuum cups usage on rough surfaces. We used a vacuum cup Vuototechnica S.r.l (model number 08 127 15 OF) and a small electric vacuum pump (Airpon MODEL D2028, 12 v, 12 LPM Freeflow, 16 inHg). Unctuous materials tested were: uncured silicone (caulking type), hair styling gel, paste-like wax, toothpaste and petroleum jelly. On each test, we started with a fresh clean vacuum cup, then we spread at least 2 mm of material on the outer wall of the cup, activated the vacuum pump and contacted the cup to a cleaned portion of a painted rough concrete-block wall. Observed variables were: whether a vacuum of 20 in of Hg was reached, (all succeeded); adherence to the wall after pump stops (all of them stayed a long time (at least several seconds) except for hair styling gel that lost its vacuum within at least 1 second); initial force required to seal surface and initiate vacuum (our observation is that the force is generally inversely proportional to a thickness of unctuous material spread in that the less material spread within the range of 2-4 mm, the greater the force needed to seal surface for vacuum initiation; each sample behaved in the same way except for uncured silicon, which is more tacky and proves easier to initiate vacuum regardless of thickness); and horizontal friction in the contact plane (our observation is that if there is too much unctuous material on the outer wall, a quantity will “flow” between surfaces and will make suction cup slip down the wall). Uncured silicon has tack, and shows best horizontal friction whereas hair styling gel feels most slippery, all other materials behaved equally between these two.

Uncured silicon (caulking type) showed best results but because its properties greatly change when cured or dried, there are risks of using it the real world: if it is too dry at time of contact it may not improve, and may hinder sealing; and it is harder to remove and clean, although it could serve as a more permanent usage for some applications. Cure-preventative additives can be examined to maintain the caulk in its soft, uncured, state for extended periods of time. Our preference is petroleum jelly which has good performances in our application, is inexpensive, and readily available. For high-slippage applications, application of some material to the meeting surface of the cup is preferred, and a thicker layer may be preferred, such as an application of 2 mm or greater. For high-friction applications, the thickness may be less than 3 mm. If rapid grasping of surfaces is desired, a ridge extending 0.5-2 mm is preferred. It is believed that a variety of materials with dynamic viscosities between 10-1000 Pas can perform substantially equivalently. These materials may have the unctuousness (thickness or body) of ketchup, honey, grease, smooth peanut butter, or petroleum jelly.

Finally, the BAM with petroleum jelly coated open pore polymeric walls was used to attach a SAV to a concrete wall. The BAM carried the cups as described hereinabove, the small electric vacuum pump Airpon MODEL D2028 driven by on-board batteries. 4 pumps. The SAV with the BAM had a weight in excess of 10 kg, and adhered to a vertical concrete wall, perched for a duration of 1 min, while the pump was on. The BAM was coupled to the SAV by an actuable joint which was used to orient the BAM with respect to the SAV. The SAV was attached on a first attempt and did not “bounce” on contact with the concrete wall as is so often observed without the unctuous material. A vacuum sensor was used to ensure depressurization and a circuit was used to control the on-board pump. Power was supplied via batteries of the SAV. While the pump was not in fact turned off during the perch, FIG. 11 shows the rotors of the SAV were powered down and the weight of the SAV was entirely borne by the BAM. It is believed that the SAV would have been supported for a long duration with intermittent depressurization.

FIG. 12 shows a single cup BAM desirably used for lighter weight drones for which the present invention is desirably applied.

Further examples of the invention have been demonstrated since the provisional filing, that have moved our preference away from petroleum jelly, towards lower cost, water-soluble, thickened aqueous solutions, at least when it is desirable for residue to be removed by precipitation. Applicant has examined materials that minimize residue, for example such as water-soluble solutions and suspensions of waxes and sugars. So while a substance like petroleum jelly improves the adhesion of a foam-based vacuum cup on rough and porous surfaces, it leaves a residual marking on docked surfaces once the vacuum cup is removed. Petroleum jelly is not water soluble and therefore cannot be easily washed away when that would be desirable, for example on hard to reach aerial structures.

Water-soluble, thickened aqueous solutions: An array of water soluble unctuous materials can be used as an alternative to petroleum jelly allowing a foam-based vacuum cup to make a robust and stable attachment to porous and rough surfaces in the same method as described hereinabove. Applicant has found that gel-like solutions made with a water soluble thickening agent provides the same benefits as petroleum jelly, without leaving as permanent a residue on the surface. The residue from petroleum jelly is visible from a distance, and is very slow to evaporate, dissolve, or efface exposed to wind, sunlight, or precipitation. After application of the gel-like solutions, the unctuous materials evaporates and dries up leaving difficult to discern vestiges on the surface that is liable to being washed away by precipitation.

Water-based unctuous materials performed similarly to petroleum jelly in vacuum cup tests, in that when the water-based unctuous materials is applied to the outside surface of the foam, it allows for the vacuum cup to adapt to rough and porous surfaces by sealing the leaks and creating a good seal with the irregular surface. It requires less power to create and maintain a sufficient vacuum for a drone or autonomous vacuum gripper to remain docked on the rough, unprepared surface.

A 1-4% (by mass) guar gum solution in water and a 4-7% ThickenUp Clear™ solution enabled the vacuum cup to make and maintain a good seal on a porous concrete panel. The ThickenUp Clear is understood to be a Xanthan gum-based, clear, water soluble thickener. In either case, a remarkable change in body or unctuousness of the material is provided with small concentration of thickener.

The viscosity of the unctuous materials that passed the vacuum test are estimated to be about 60-100×10⁴ centipoise. It is believed that many other gel-like solutions made with a water soluble thickening agents and with a viscosity between 10⁴ to 10⁶ centipoise provide the same benefits. The vacuum test involved applying the substance to Vuototecnica OF FOAM RUBBER foam strips of 10×20 mm, coupling the vacuum cup to an Airpo™ vacuum pump from RobotShop, and determining whether a seal is produced.

A guar gum solution of 4% worked well and felt similar to petroleum jelly, although the texture is a bit lumpy compared to Thicken Up. Guar gum is composed of galactose and mannose (complex carbohydrate polymers) and creates a hydrogen bond with water molecules. Residue washes away with water but is a bit more resistant than Thicken Up.

The Thicken Up material was mixed in two concentrations: 3.6% which didn't work, and 7.2%, which did work. In both cases the material doesn't clump and readily washes away with water. The 3.6% Thicken Up solution was a watery gel texture that is too liquid for the vacuum test and the material did not stick to the vacuum cup. This concentration has a reported viscosity of 20-30 k cp. At 7.2% the material is not lumpy and has a gel-like texture that is more slimy and liquid-like than the guar gum solution. It passed the test of application to the foam, and it passed the vacuum test.

Other materials were tried and didn't work. A xanthan gum powder of around 2.4% concentration did not work. It tended to clump up far more than guar gum, and requires more mixing, and that the powder be incorporated slowly with a vortex mixer, which was not available for these tests. Still it is a promising option if lower concentrations can be produced, as a smallest concentration of thickener leaves the least residue and costs the least to produce. Finally a non-petroleum jelly, branded live Clean™, was found not amenable to washing with water, and therefore wasn't tried.

Different foam pore size foams: A variety of suction cups with different types of foam have been made and tested, including 3 open cell foams obtained from McMaster-Carr of California, USA, to show how the unctuous sealing materials operate on a variety of foams, and particularly assess whether there are some pore distributions that work particularly well or poorly. Each open cell foam made a good seal on the porous painted concrete wall with the help of a water-based unctuous material. A guar gum solution and a ThickenUp solution were tried on each foam. Each open cell foam improve suction when used with the unctuous material. In no case did gel material leak from the outside surface all the way into the vacuum chamber, however some evidence of infiltration of the lighter foams was observed visually by a discolouration.

The same vacuum test was applied to each cup and each cup passed the test. Accordingly it can be concluded that a wide variety of open pore crushable barrier walls formed of foamed polymer can be used. Each suction cup was applied to each cup, and all passed the vacuum test.

TABLE 1
foam properties from supplier

| Cell | | Density in | Pressure to |
|---|---|---|---|
| type | Name | air (g/cm) | compress 25% (kPa) |
| Open | Super-Cushioning | 0.016 | 2.1 |
| | PU Foam Circle | | |
| | Super-Cushioning PU | 0.032 | Not rated |
| | Foam Sheet | | |
| | Super-Cushioning | 0.096 | 1.4 |
| | Ultra-Conformable | | |
| | Foam Sheet | | |

The present invention has therefore been illustrated in terms of a vacuum gripper, and a kit for forming the same, as well as a method for vacuum gripping a rough surface. The vacuum gripper with a barrier wall formed of an open pore crushable material, with an applied unctuous sealing material, has been found to substantially improve at least one of: a persistence of attachment, a duration of attachment for a given vacuum; a strength of attachment from a given pump; and a time, force, or angular alignment required to initiate vacuum suction.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A kit for sealing a vacuum gripper, the kit comprising:
a volume of at least 100 mL of an unctuous sealing material, the material exhibiting solidity, or a viscosity greater than 10⁴ centipoise when subjected to no shear force greater than 1 kPa, and exhibiting a viscosity less than 10⁶ centipoise under a shear stress of 0.1 to 100 kPa;
and at least one of:
A) an applicator adapted to spread the material over at least one of an inner side or outer side of a barrier wall of an open pore crushable suction cup, the applicator having a spreading surface 0.5-20 cm deep extending from a handle, and a loading area for retaining the material prior to spreading; and
B) a suction cup with:
a resiliently crushable, open pore, barrier wall mounted to a support, the wall in a relaxed pose having a height of 0.5-20 cm, and a lip thickness of 0.5-20 cm that is 0.5 to 5 times the wall height;
the support and wall surrounding an inner volume of the cup having a mean outer dimension extent of 3-200 cm and a periphery of 10-1500 cm;
the support having a stiffness higher than that of the barrier wall such that a force applied on the barrier wall deflects the barrier wall more than the support; and
a sealed pressure port supported by the support for controlled evacuation of the inner volume.

2. The kit of claim 1 wherein the kit comprises the applicator, and the applicator:
is specifically adapted to spread the material over one of sides of the wall without covering the lip of the cup, whereby when the cup, with the material applied, comes into contact with a surface, some of the lip of the wall comes into contact with the surface without any of the material in between;
is specifically adapted to spread the material over one of the sides of the barrier wall to form a ridge that extends beyond a maximum height of the barrier wall; or
further comprises a registration feature that aligns with a feature of a support of a suction cup for which use is intended, to facilitate manual alignment of the spreading surface and the inner or outer side of the barrier wall.

3.-4. (canceled)

5. The kit of claim 1 wherein the kit comprises the cup, and: the support comprises a plate; the vacuum port extends through the support into the inner volume; the support has one or more cleats, barbs or spacers for contacting an object; or the support comprises a surface for mounting a vacuum pump coupled to a pressure port of the cup.

6. The kit of claim 1 wherein the kit comprises the cup, and the support comprises a contracting type suction cup body with a thick lip to which the open pore crushable barrier wall is adhered, the contracting type suction cup body comprising one of a telescoping mechanism, and a bellows type elastomeric suction cup body.

7. The kit of claim 1 wherein the material is: non-Newtonian fluid exhibiting pseudoplasticity; a non-Newtonian fluid exhibiting thixotropy; a non-Newtonian fluid with a plastic yield limit stress, like a Bingham plastic or pseudoplastic; or a Newtonian fluid.

8.-10. (canceled)

11. The kit of claim 1 wherein the material has a static coefficient of friction of at least 0.08, and gas permeability below 0.2 liter per minute.

12. The kit of claim 1 wherein the material: has a lack of visible marking on contact with a preferred class of objects; has an identifiable visible marking on contact with a preferred class of objects; is non-toxic; is environmentally inert; is biodegradable; is visible on the edge of the suction cup; is resistant to: vibration; irradiation; extreme temperature; temperature fluctuations; or a class of chemicals; or is inflammable.

13. The kit of claim 1 wherein the material is a stabilized, macroscopically homogeneous, mixture including at least one wax, or solid or ionic cured polymer component and at least one oil, or liquid component.

14. The kit of claim 13 wherein the liquid component is water which comprises by weight more than 90 wt. % of the material, and the solid or cured polymer component consists of an organic thickener comprising a carbohydrate gum, or cellulose-based or -derived material.

15. The kit of claim 13 wherein the material comprises a partially refined petroleum jelly.

16. The kit of claim 1 wherein the kit comprises the cup, and further comprises: a portable pump adapted for coupling to the sealed pressure port; a portable power supply for the pump; a pressure sensor coupled to the cup for determining a pressurization of the cup; a controller for controlling the pump in response to the sensor; a sensor, a loudspeaker, an audio recorder, a motion controlled platform, a robotic arm, a laser, a light, a camera, a motorized vehicle, a mounting bracket, a latching mechanism, or an electronic circuit for: processing data from, or for controlling, any of the above, or for wireless communications.

17. (canceled)

18. The kit of claim 1 wherein the support has one or more mounting surfaces for holding: a pump, a sensor, a loudspeaker, an audio recorder, a motion controlled platform, a laser, a light, a camera, an electronic circuit for processing data from the camera, recorder, or sensor, an electronic circuit for wireless communications, a motorized vehicle, or a mounting bracket.

19. (canceled)

20. The kit of claim 1 in assembled form.

21. A vacuum gripper comprising:
a suction cup with an open pore crushable barrier wall extending from a support, the wall having a height of 0.5-20 cm, a lip thickness of 0.5-20 cm, that is 0.5 to 5 times the height, the wall and support surrounding an inner volume to define the cup, the barrier wall having a mean outer dimension extent of 3-800 cm, and a periphery of 10-1500 cm; and
an unctuous sealing material sealing around at least one of an inner side or outer side of the barrier wall, the material exhibiting a solidity or viscosity greater than 10⁴ centipoise when subjected to shear forces of less than 1 kPa, and exhibiting a viscosity less than 6 centipoise under shear stress of 100 Pa or more.

22. The vacuum gripper of claim 21 wherein: the material's viscosity decreases with increasing shear force; or the material has a non-zero yield shear strain like a Bingham pseudoplastic has, with a yield shear strain value between 10 Pa and 10 kPa.

23.-25. (canceled)

26. The vacuum gripper of claim 22 wherein the yield shear strain has a value between 0.3 and 3 kPa.

27. (canceled)

28. The vacuum gripper of claim 21 wherein the viscosity under shear stress is between 1 and 10⁴ centipoise.

29. The vacuum gripper of claim 21 wherein the vacuum plate is mounted to a vacuum source having an attachment feedback sensor whereby the vacuum gripper can autonomously regulate grasping of an object to which it is mounted.

30. (canceled)

31. A method for vacuum gripping a rough surface, the method comprising:
providing a suction cup with an open pore crushable barrier wall extending from a support, the wall having a height of 0.5-20 cm, a lip thickness of 0.2-20 cm that is 0.5-5 times the height, and the wall and support surrounding an inner volume to define the cup, the wall having a mean outer dimension extent of 3-800 cm, and a periphery of 10-1500 cm;
applying an unctuous sealing material sealing around at least one of an inner side or outer side of the barrier wall, the material exhibiting solidity, or viscosity greater than 10⁴ centipoise, when subjected to shear forces of less than 1 kPa, and exhibiting a viscosity less than 10⁶ centipoise under shear stress of 100 Pa or more; and
placing the suction cup against the rough surface while drawing a vacuum on the inner volume, so that the wall crushes, the material seals the cup, and the support approaches the rough surface.

32. The method of claim 31 wherein:
applying the material comprises:
spreading the material on the outer side so that in a crushed, evacuated pose, the material is distributed over the one barrier surface with enough uniformity so that at least 1 mm of the material is provided as a minimum, and a thickness of the material varies by less than 4 mm across the one barrier surface, with less than 10% of the material on an inner side or meeting surface of the wall; or
forming a ridge of the material continuously around the wall, the ridge extending from the outer side of the wall and extending away from the support higher than a meeting surface of the wall;
method further comprises mounting the suction cup to a moving platform, and placing the suction cup vacuum gripper comprises operating the moving platform, the moving platform being a crawling, rolling, flying, hovering, or floating vehicle; or a kinematic machine; or
the suction cup is coupled to a pump with a portable power supply, a mechanical grip, a controller, and a sensor to define an autonomous system for maintaining attachment of a body to a rough wall of a structure via the grip, where the controller is adapted to receive a signal indicating a loss of depressurization of the cup, and triggers activation of the pump to maintain attachment.

33.-36. (canceled)
